(19) United States
(12) Patent Application Publication
(10) Pub. No.: US 2003/0174674 A1
(43) Pub. Date: Sep. 18, 2003

(54) System and method for transmitting and displaying messages in a mobile terminal

(75) Inventors: Young-Jo Lee, Gyeonggi-do (KR); Chan-Ho Kyung, Incheon (KR); Jong-Hoe An, Gyeonggi-do (KR)

Correspondence Address: FLESHNER & KIM, LLP, P.O. Box 221200, Chantilly, VA, 20153-1200, US

(73) Assignee: LG Electronics Inc.

(21) Appl. No.: 10/386,673

(22) Filed: Mar. 13, 2003

(30) Foreign Application Priority Data
Mar. 13, 2002 (KR) P2002-14613

(51) Int. Cl. H04Q 7/00

(52) U.S. Cl. 370/331

(57) ABSTRACT

Disclosed are a method for performing handoff by a mobile station in idle state and supporting the handoff by a base station which is to provide a method for performing handoff and supporting the handoff which is able to perform the handoff without entering into system determination substate when the mobile station in idle state moves from the coverage of the base station not supporting new common channels into the coverage of the neighbor base station supporting new common channels.

This application claims the benefit of the Korean Application No. P2002-14613 filed on Mar. 13, 2002, which is hereby incorporated by reference.

### BACKGROUND OF THE INVENTION

1. Field of the Invention

The present invention relates to a mobile communication, and more particularly to a method for performing handoff by a mobile station in idle state and supporting the handoff by a base station.

2. Background of the Related Art

Typically, the states of a mobile station is divided into initialization state, idle state, system access state and state communicating with a base station. An idle handoff is carried out when the mobile station is in idle state.

The idle handoff occurs when the mobile station moves from the coverage of one base station into the coverage of another base station during the mobile station in idle state.

When the mobile station detects a pilot channel signal from the neighbor base stations, if the detected pilot channel signal is sufficiently stronger than that of the current serving base station, the mobile station determines that an idle handoff should occur.

Pilot channels are identified by their offsets relative to the zero offset pilot PN (Pseudo Noise) sequence. Pilot offsets are grouped into sets describing their status throughout pilot searching.

Sets of pilot offsets for a mobile station in idle state is defined as active set, neighbor set, and remaining set.

Active set is a pilot offset of a paging channel or a forward common control channel (F-CCCH) being monitored. In detail, active set is the pilot offset of the present serving base station.

The members of the neighbor set are specified in the Neighbor List Message (NLM), the Extended Neighbor List Message (ENLM), and the General Neighbor List Message (GNLM), and the Universal Neighbor List Message (UNLM) on a broadcast control channel.

A Mobile station performs an idle handoff by referring to sets of pilot offsets provided by the Neighbor List Message, the Extended Neighbor list message, the General Neighbor List Message and the Universal Neighbor List Message on the broadcast control channel (BCCH).

If the mobile station supports new common channels while the serving base station does not support new common channels, the mobile station just receives the reference information of the paging channel from that serving base station. Therefore, even if the mobile station performs handoff to one of the neighbor base station supporting new common channels, that mobile station just receives the paging channel from the neighbor base station. Namely, the mobile station cannot receive new common channels such as BCCH (Broadcast Control Channel) or F-CCCH (Forward-Common Control Channel). This occurs because mobile station cannot receive any information through the new common channels like the BCCH (Broadcast Control Channel) and the F-CCCH (Forward-Common Control Channel).

The protocol revision level of the mobile station supporting the new common channels mentioned above is “MOB_P_REV≧7”. And the protocol revision level of the serving base station supporting the new common channels is “P₁₃ REV≦6”. The protocol revision level of the neighbor base station supporting new common channels is P_REV≧7.

Consequently, as illustrated in FIG. 1, for the mobile station in idle state returns to the initialization state, the mobile station ought to go through procedure for initialization after the idle handoff occurred according as the mobile station in idle state moves from the coverage of a base station supporting new common channels into the coverage of a neighbor base station supporting new common channels.

Namely, a state of the mobile station turn into idle state after respectively going through the procedures of the system determination substate, the pilot channel acquisition substate and the synchronization channel acquisition substate.

As mentioned in the prior art, the mobile station is able to return to an idle state after it acquires a synchronization channel during the system determination substate for initialization when the mobile station performs an idle handoff according to moving from the coverage of the base station not supporting the new common channels into the coverage of the neighbor base station supporting new common channels. As a result, there was a problem of long lapse of time for the mobile station to perform the idle handoff.

In addition, since few existing a mobile station fail to acquire a synchronization channel in the coverage of the base station B of “P_REV≧7”, the synchronization channel solution is proposed to solve these problems. But if the mobile station in idle state returns to the initialization state after the mobile station goes through the procedure of the idle handoff according to moving from the coverage of the base station A not supporting new common channels into the coverage of the neighbor base station B supporting new common channels.

### SUMMARY OF THE INVENTION

Accordingly, the present invention is directed to a method for performing handoff and supporting the handoff that substantially obviates one or more problems due to limitations and disadvantages of the prior art.

The object of the present invention is to provide a method for performing handoff and supporting the handoff which is able to perform the handoff without entering into system determination substate when the mobile station in idle state moves from the coverage of the base station not supporting new common channels into the coverage of the neighbor base station supporting new common channels.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for performing handoff as a mobile station moves from a coverage of a first base station not supporting new common channels into a coverage of a second base station according to the present invention comprises (a) receiving at least one overhead message of a paging channel transmitted from the second base station, (b) checking a first field (BCCH_INCL) in the overhead message that indicates whether a reference information of a Broadcast Control Channel (BCCH) is included, wherein the BCCH is one of the new common channels, (c) extracting information required to decode the BCCH from the overhead message if the reference information of the BCCH is included in the overhead message, (d) selecting one of BCCH frequencies using the extracted information, and (e) monitoring the BCCH with the selected BCCH frequency.

Preferably, wherein the at least one overhead message received in step (a) includes an extended CDMA channel list message (ECCLM) of the paging channel.

More preferably, wherein the at least one overhead message received in step (a) further included an extended system parameter message (ESPM) of the paging channel.

More preferably, further comprising the step of checking whether the mobile station enters into a system determination substate for initialization by checking a second field (BCCH_SUPPORTED) that indicates whether the BCCH is supported, wherein the second field (BCCH_SUPPORTED) is one of ESPM fields the first field (BCCH_INCL) is one of ECCLM fields.

More preferably, wherein even if it is indicated in the second field (BCCH_SUPPORTED) of the ESPM that the BCCH is supported, the mobile station does not enter into the system determination substate for initialization if it is indicated in the first field (BCCH_INCL) of ECCLM that the reference information of the BCCH is included.

Preferably, further comprising the steps of selecting one of paging channel frequencies when it is indicated in the first field (BCCH_INCL) that the reference information of the BCCH is not included, and monitoring the paging channel with the selected frequency.

More preferably, wherein the paging channel frequency is selected by hashing a plurality of frequencies supporting the paging channel.

Preferably, wherein the at least one overhead message received in step (a) includes an extended CDMA channel list message (ECCLM) of paging channel, and the information required to decode the BCCH is extracted from ECCLM.

Preferably, wherein the information required to decode the BCCH include the BCCH frequencies, a data rate, a code rate, and Walsh information.

Preferably, in the (d) step, wherein the BCCH frequency is selected by hashing a plurality of frequencies supporting the BCCH.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates diagram explaining the general handoff between the base stations;

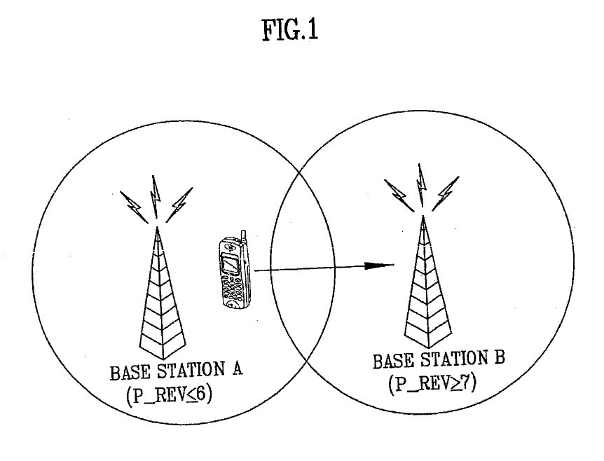

FIG. 2 illustrates a procedure of an idle handoff according to a first embodiment of the present invention; and

FIG. 3 illustrates a procedure of an idle handoff according to a second embodiment of the present invention.

### DETAILED DESCRIPTION OF THE PREFERRED EMBODIMENTS

Reference will now be made in detail to the preferred embodiments of the present invention, examples of which are illustrated in the accompanying drawings. The present invention now will be described more fully with reference to the accompanying drawings, in which preferred embodiments of the invention are shown. This invention may, however, be embodied in many different forms and should not be construed as being limited to the embodiments set forth herein.

In the following detailed description, the present invention explains the procedure for performing an idle handoff when a mobile station moves from the coverage of one base station A of “P_REV≦6” not supporting new common channels into the coverage of a neighbor base station B of “P_REV≧7” supporting the new common channels during the mobile station in idle state.

And the present invention also explains the method of supporting the idle handoff of a mobile station by the neighbor base station B when the mobile station comes into the coverage of the neighbor base station B during the mobile station in idle state. Particularly, the present invention supports for the mobile station in idle state not to return into the initialization state when the mobile station in idle state comes into the coverage of the neighbor base station B in order to prevent an error of the synchronization channel solution.

The mobile station (MOB_P_REV≧7) referred in the present invention supports new common channels. That is, the mobile station is one that is able to handle new common channels supported by base station B.

In the above mentioned, the “P_REV” is a value that indicates the protocol revision level of the base station and the “MOV_P_REV” is that of the mobile station.

In the coverage of the base station A of “P_REV≦6”, the mobile station obtains information about plural neighbor base stations through GNLM (General Neighbor List Message) transmitted over a paging channel. With that reason, the mobile station just obtains the reference information of the paging channels of plural neighbor base stations from a base station A. As a result, the mobile station just obtains the paging channels even if the mobile station performs handoff from the coverage of the base station A of “P_REV≦6” to the coverage of the base station B of “P_REV≧7”.

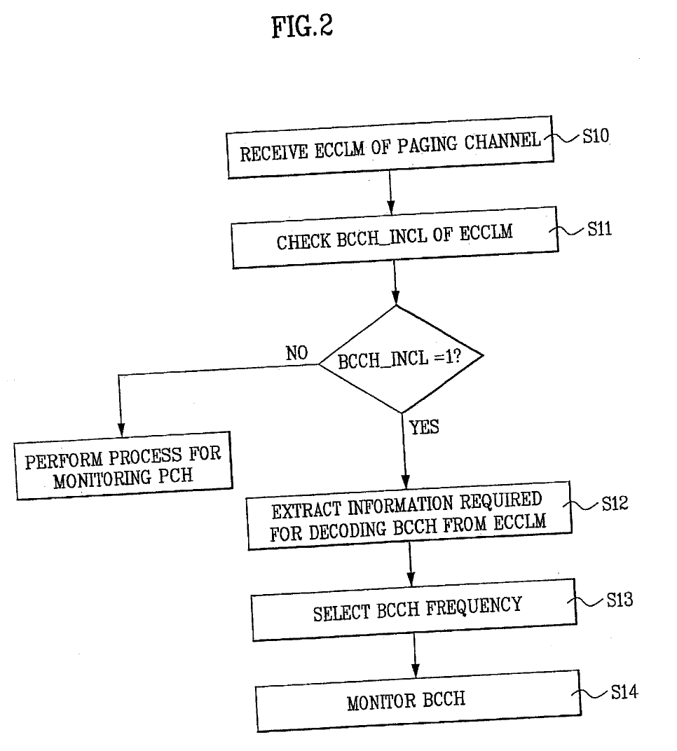

FIG. 2 illustrates a procedure of an idle handoff according to a first embodiment of the present invention. In the FIG. 2, the idle handoff is performed when the base station in idle state moves to the coverage of the base station A (P_REV≦6) not supporting new common channels into the coverage of the neighbor base station B (P_REV≧7) supporting new common channels.

Referring to FIG. 2, the mobile station receives an overhead message of a paging channel transmitted from the neighbor base station B (S10). In detail, the mobile station receives an extended CDMA channel list message (ECCLM) of a paging channel transmitted from the neighbor base station B.

Herein, the mobile station receives another overhead message of the paging channel transmitted from the neighbor base station B, which is an extended system parameter message (ESPM) of the paging channel.

But the base station B transmits the extended system parameter message (ESPM) that includes whether BCCH (Broadcast Control Channel) is supported. That reason is to prevent the mobile station from entering into a system determination substate for initialization. For the procedure, the base station B transmits the extended system parameter message (ESPM) either removing a BCCH_SUPPORTED field to indicate whether the BCCH (Broadcast Control Channel) is supported or being the value of the BCCH_SUPPORTED field set to zero. Herein, if the value of the BCCH_SUPPORTED field sets to zero, it indicates the BCCH (Broadcast Control Channel) is not supported. If the value of the BCCH_SUPPORTED field sets to 1, it indicates the BCCH (Broadcast Control Channel) is supported.

Subsequently, the mobile station checks a BCCH_INCL field of an extended CDMA channel list message (ECCLM) which is an overhead message received on the paging channel (S11). Herein, the BCCH_INCL field is the field used to indicate whether reference information of the BCCH (Broadcast Control Channel) which is one of the new common channels is included in the extended CDMA channel list message (ECCLM). For instance, in case 1 bit is allotted for BCCH_INCL field, if the value of the BCCH_INCL field sets to zero, it indicates reference information of BCCH (Broadcast Control Channel) is not included in the extended CDMA channel list message (ECCLM). Otherwise, the value sets to 1, it indicates that is included in. Herein, the reference information of the BCCH (Broadcast Control Channel) is BCCH frequencies, a data rate, a code rate and Walsh information required to decode the BCCH (Broadcast Control Channel).

If it is indicated in the BCCH_INCL field for reference information of BCCH (Broadcast Control Channel) to be included, the mobile station extracts information required to decode the BCCH (Broadcast Control Channel) from the extended CDMA channel list message (ECCLM) (S12).

Subsequently, the mobile station selects one of the frequency supporting the BCCH (Broadcast Control Channel) using the extracted information (S13). In detail, because the mobile station is able to know the number of frequencies supporting the BCCH (Broadcast Control Channel), the mobile station selects an proper frequency performing hashing for the number of frequencies.

Lastly, the mobile station monitors the BCCH (Broadcast Control Channel) with the selected frequency (S14). Herein, which mobile station monitors the BCCH (Broadcast Control Channel) means the state of the mobile station in idle is maintained. This is, because the mobile station in idle state generally monitors a paging channel or BCCH (Broadcast Control Channel)/F-CCCH (Forward-Common Control Channel).

Consequently, when the mobile station (MOB_P_REV≧7) performs handoff from the coverage of the base station A of “P_REV≦6” to the coverage of the neighbor base station B of “P_REV≧7”, the mobile station maintains its idle state without entering into a system determination substate for initialization.

But if the mobile station of “MOB_P_REV≧7” moves into a neighbor base station of “P_REV≦6”, the neighbor base station of “P_REV 6” forwards message (ECCLM) having the BCCH_INCL field being indicated for reference information of the BCCH (Broadcast Control Channel) not to be included. In such case, the mobile station selects one of the frequency supporting the paging channel. In detail, mobile station selects the proper frequency by hashing the frequencies that can support the paging channel of the base station B of “P_REV≦6”. After the selection of the frequency, the mobile station monitors the paging channel with the selected frequency.

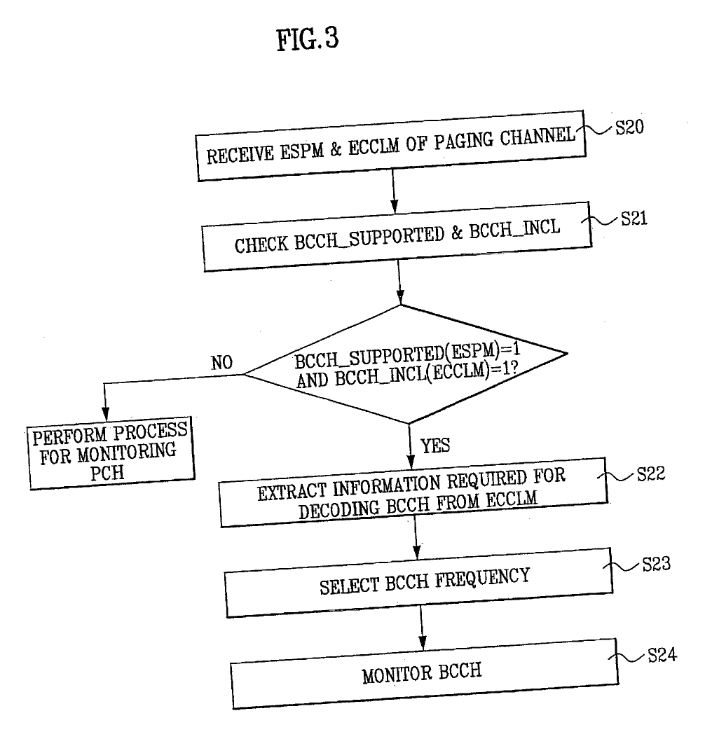

FIG. 3 illustrates a procedure of an idle handoff according to a second embodiment of the present invention. In the FIG. 3, the idle handoff is performed according as the base station of “P_REV≧7” transmits an extended system parameter message (ESPM) and an extended CDMA channel list message (ECCLM)as the overhead messages of a paging channel.

Referring to FIG. 3, the mobile station receives an extended system parameter message (ESPM) and an extended CDMA channel list message (ECCLM) of a paging channel transmitted from the neighbor base station B (S20).

Subsequently, the mobile station checks a BCCH_SUPPORTED field of the extended system parameter message (ESPM) and a BCCH_INCL field of the extended CDMA channel list message (ECCLM) (S21). Herein, the messages are the overhead messages received on the paging channel. Herein, the BCCH_SUPPORTED field is the field used to indicate whether the BCCH (Broadcast Control Channel) which is one of the new common channels is supported or not. For instance, in case 1 bit is allotted for BCCH_SUPPORTED field, if the value of the BCCH_SUPPORTED field sets to zero, it indicates the base station B supports the BCCH (Broadcast Control Channel). Otherwise, the value sets to 1, it indicates the base station B does not support the BCCH. In case 1 bit is also allotted for BCCH_INCL field, if the value of the BCCH_INCL field sets to zero, it indicates reference information of BCCH (Broadcast Control Channel) is not included in the extended CDMA channel list message (ECCLM). Otherwise, the value sets to 1, it indicates that is included in. Herein, the reference information of the BCCH (Broadcast Control Channel) is BCCH frequencies, a data rate, a code rate and Walsh information required to decode the BCCH (Broadcast Control Channel).

If it is indicated in the BCCH_SUPPORTED field for the BCCH (Broadcast Control Channel) to be supported and in the BCCH_INCL field for reference information of BCCH (Broadcast Control Channel) to be included, the mobile station maintains its idle station without entering into a system determination substate for initialization. In the Present invention, the mobile station determines whether to enter into the system determination substate for initialization or not to after the mobile station checks both the values of the BCCH_SUPPORTED field and the BCCH_INCL field and analyzes the fields.

If it is indicated in the BCCH_SUPPORTED field for the BCCH (Broadcast Control Channel) to be supported and in the BCCH_INCL field for reference information of BCCH (Broadcast Control Channel) not to be included, the mobile station enters into the system determination substate for initialization.

On the other hand, since the base station B of “P_REV≧7” supports new common channels (BCCH, F-CCCH), the base station B always indicates in the BCCH_INCL field that reference information of BCCH (Broadcast Control Channel) is included.

The Mobile station maintaining idle state extracts information required to decode BCCH (Broadcast Control Channel) from the extended CDMA channel list message (ECCLM) when it is indicated in BCCH_SUPPORTED field for the BCCH (Broadcast Control Channel) to be supported and in BCCH_INCL field for reference information of BCCH (Broadcast Control Channel) to be included (S22).

Subsequently, the mobile station selects one of the frequencies supporting the BCCH (Broadcast Control Channel) using the extracted information (S23). In detail, because the mobile station is able to know the number of frequencies supporting the BCCH (Broadcast Control Channel), the mobile station selects an proper frequency performing hashing for the number of frequencies.

Finally, the mobile station monitors the BCCH (Broadcast Control Channel) with the selected frequency (S24). Additionally, according to another embodiment of the present invention, the mobile station can also monitor Forward-Common Control Channel (F-CCCH) along with the BCCH (Broadcast Control Channel).

Herein, which mobile station monitors the BCCH (Broadcast Control Channel) means the state of the mobile station in idle is maintained. This is, because the mobile station in idle state generally monitors a paging channel or BCCH (Broadcast Control Channel)/F-CCCH (Forward-Common Control Channel).

Consequently, when the mobile station (MOB_P_REV≧7) performs handoff from the coverage of the base station A of “P_REV≦6” to the coverage of the base station B of “P_REV≧7”, the mobile station maintains its idle state and performs the handoff without entering into the system determination substate for initialization.

However, in theory a case where it is indicated in the BCCH_SUPPORTED field for the BCCH (Broadcast Control Channel) to be supported but indicated in the BCCH_INCL field for reference information of BCCH not to be included. But such case shall not occur in reality. The reason is when the neighbor base station of “P_REV 7” indicates in the BCCH_SUPPORTED field the BCCH (Broadcast Control Channel) being supported, it also justly indicates in the BCCH_INCL field the reference information of the BCCH being included. In contrast, when the neighbor base station of “P_REV 7” indicates in the BCCH_SUPPORTED field the BCCH (Broadcast Control Channel) not being supported, it also justly indicates in the BCCH_INCL field the reference information of the BCCH not being included.

The idle handoff of the mobile station described in the above is made possible by using the following a method of supporting the handoff performed by the base station B.

The base station B supporting the new common channels including the BCCH transmits an extended system parameter message (ESPM) in which is indicated for BCCH (Broadcast Control Channel) not to be supported. That reason is to prevent the mobile station from entering into a system determination substate for initialization. In detail, the base station B transmits the extended system parameter message (ESPM) either removing a BCCH_SUPPORTED field to indicate whether the BCCH (Broadcast Control Channel) is supported or being the value of the BCCH_SUPPORTED field set to zero. Herein, if the value of the BCCH_SUPPORTED field sets to zero, it indicates the BCCH (Broadcast Control Channel) is not supported. If the value of the BCCH_SUPPORTED field sets to 1, it indicates the BCCH (Broadcast Control Channel) is supported.

The base station B transmits an extended CDMA channel list message (ECCLM) included reference information of BCCH (Broadcast Control Channel).

In this case, the base station B transmits the extended CDMA channel list message (ECCLM) that indicates whether reference information of BCCH (Broadcast Control Channel) is included. The field used to indicate whether reference information of BCCH (Broadcast Control Channel) is included is a BCCH_INCL field of the extended CDMA channel list message (ECCLM). For instance, if the value of the BCCH_INCL field sets to zero, it indicates reference information of BCCH (Broadcast Control Channel) is not included in the extended CDMA channel list message (ECCLM). Otherwise, the value sets to 1, it indicates that is included in As a result, the base station B supporting new common channels sets the value of the BCCH_INCL field to zero and then transmits the field. Herein, the reference information of BCCH (Broadcast Control Channel) is BCCH frequencies, a data rate, a code rate and Walsh information required to decode the BCCH (Broadcast Control Channel).

Particularly, if the neighbor base station of “P_REV≧7” transmits the BCCH_SUPPORTED field of the extended system parameter message (ESPM) indicated BCCH (Broadcast Control Channel) is supported, also transmits the BCCH_INCH field of the extended CDMA channel list message (ECCLM) indicated reference information of BCCH (Broadcast Control Channel) is included in the extended CDMA channel list message (ECCLM).

In contrast, if the neighbor base station of “P_REV≧7” transmits the BCCH_SUPPORTED field of the extended system parameter message (ESPM) indicated BCCH (Broadcast Control Channel) is not supported, also transmits the BCCH_INCH field of the extended CDMA channel list message (ECCLM) indicated reference information of BCCH (Broadcast Control Channel) is not included in the extended CDMA channel list message (ECCLM).

Accordingly, in the method for performing handoff and supporting the handoff according to the present invention, since the mobile station does not enter into a system determination substate during an idle handoff, the time delay required to return to an idle state from a system determination substate after the idle handoff can be reduced.

In addition, as shown in the present invention, since it does not require a mobile station to return to a system determination substate during the procedure of the idle handoff being performed according as the mobile station moves from the coverage of a base station A of “P_REV≦6” into the coverage are of a base station B of “P_REV≧7”, an error of the synchronization channel solution can be prevented.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method for performing handoff when a mobile station moves from a coverage of a first base station not supporting new common channels into a coverage of a second base station, the method comprising the steps of:
(a) receiving at least one overhead message of a paging channel transmitted from the second base station;
(b) checking a first field in the overhead message that indicates whether a reference information of a Broadcast Control Channel (BCCH) is included, wherein the BCCH is one of the new common channels;
(c) extracting information required to decode the BCCH from the overhead message if the reference information of the BCCH is included in the overhead message;
(d) selecting one of BCCH frequencies using the extracted information; and
(e) monitoring the BCCH with the selected BCCH frequency.

2. The method of claim 1, wherein the at least one overhead message received in step (a) includes an extended CDMA channel list message (ECCLM) of the paging channel.

3. The method of claim 2, wherein the at least one overhead message received in step (a) further included an extended system parameter message (ESPM) of the paging channel.

4. The method of claim 3, further comprising the step of:
checking whether the mobile station enters into a system determination substate for initialization by checking a second field (BCCH_SUPPORTED) that indicates whether the BCCH is supported, wherein the second field (BCCH_SUPPORTED) is one of ESPM fields the first field (BCCH_INCL) is one of ECCLM fields.

5. The method of claim 4, wherein even if it is indicated in the second field (BCCH_SUPPORTED) of the ESPM that the BCCH is supported, the mobile station does not enter into the system determination substate for initialization if it is indicated in the first field (BCCH_INCL) of ECCLM that the reference information of the BCCH is included.

6. The method of claim 1, further comprising the steps of:
selecting one of paging channel frequencies when it is indicated in the first field (BCCH_INCL) that the reference information of the BCCH is not included; and
monitoring the paging channel with the selected frequency.

7. The method of claim 6, wherein the paging channel frequency is selected by hashing a plurality of frequencies supporting the paging channel.

8. The method of claim 1, wherein the at least one overhead message received in step (a) includes an extended CDMA channel list message (ECCLM) of paging channel, and the information required to decode the BCCH is extracted from ECCLM.

9. The method of step 1, wherein the information required to decode the BCCH include the BCCH frequencies, a data rate, a code rate, and Walsh information.

10. The method of claim 1, in the (d) step, wherein the BCCH frequency is selected by hashing a plurality of frequencies supporting the BCCH.

11. The method of claim 1, further comprising the step of:
monitoring Forward-Common Control Channel(F-CCCH) with the selected BCCH frequency, the F-CCCH is one of the new common channels.

12. A method of performing handoff when a mobile station in an idle state moves from a coverage of a first base station into a coverage of a second base station, the method comprising the steps of:
(a) receiving at least one overhead message of a paging channel transmitted from the second base station;
(b) extracting information required to decode a Broadcast Control Channel (BCCH) from the received overhead message;
(c) selecting one of the BCCH frequencies using the extracted information; and
(d) monitoring the BCCH with the selected BCCH frequency.

13. The method of claim 12, wherein the first base station does not support new common channels that includes the BCCH and the second base station supports the new common channels.

14. The method of claim 12, wherein the at least on overhead message include an extended system parameter message (ESPM) and an extended CDMA channel list message (ECCLM) of the paging channel.

15. The method of claim 14, further comprising the step of:
checking whether the mobile station enters into a system determination substate for initialization by checking a first field (BCCH_SUPPORTED) that indicates whether the BCCH is supported and a second field (BCCH_INCL) that indicates existence of reference information of the BCCH, wherein the first field (BCCH_SUPPORTED) is one of ESPM fields and the second field (BCCH_INCL) is one of ECCLM fields.

16. The method of claim 15, wherein even if it is indicated in the first field (BCCH_SUPPORTED) of ESPM that the BCCH is supported, the mobile station extracts the information required to decode the BCCH without entering into the system determination substate for initialization if it is indicated in the second field (BCCH_INCL) of ECCLM that the reference information of the BCCH is included.

17 The method of claim 14, further comprising the step of:
checking a first field (BCCH_SUPPORTED) that indicates whether the BCCH is supported, wherein the first field (BCCH_SUPPORTED) is one of ESPM fields.

18. The method of claim 17, further comprising the step of:
checking a second field (BCCH_INCL) that indicates existence of reference information of the BCCH if it is indicated in the first field (BCCH_SUPPORTED) of the ESPM that the BCCH is supported, wherein the second field (BCCH_INCL) is one of ECCLM fields.

19. The method of claim 12, wherein the information required to decode the BCCH includes the BCCH frequencies, a data rate, a code rate, and Walsh information.

20. The method of claim 12, in the (c) step, wherein the BCCH frequency is selected by hashing a plurality of frequencies supporting the BCCH.

21. A method for supporting handoff of a mobile station in an idle state that supports new common channels including a Broadcast Control Channel (BCCH), the method comprising the steps of;
(a) transmitting a first overhead message of a paging channel to the mobile station, the first overhead message including a first field indicating whether the BCCH is supported;.
(b) transmitting a second overhead message of the paging channel to the mobile station, the second overhead message including a second field indicating whether reference information of the BCCH is included;

22. The method of claim 21, wherein the first overhead message is an extended system parameter message (ESPM) transmitted through the paging channel.

23. The method of claim 21, in the (a) step, wherein the first field is removed before transmitting the first overhead message to the mobile station so that the mobile station does not enter a system determination substate for initialization.

24. The method of claim 21, wherein the first field of the first overhead message is set to zero, indicating the BCCH is not supported.

25. The method of claim 21, wherein the second overhead message is an extended CDMA channel list message (ECCLM) transmitted through the paging channel.

26. The method of claim 22, wherein the second overhead message is an extended CDMA channel list message (ECCLM) transmitted through the paging channel.

27. The method of claim 21, wherein the second field of the second overhead message is set to one, indicating the reference information of the BCCH is included.

28. The method of claim 21, in the (b) step, wherein information required to decode the BCCH is further included is the second overhead message.

29. The method of claim 28, wherein the information required to decode the BCCH includes BCCH frequencies, a date rate, a code rate, and walsh information.

30. A method of supporting handoff for a mobile station in an idle state that supports new common channels including a broadcast control channel (BCCH), the method comprising the steps of:
(a) transmitting a first an extended CDMA channel list message (ECCLM) to the mobile station, the first ECCLM indicates whether reference information of the BCCH is included; and
(b) transmitting a second an extended CDMA channel list message (ECCLM) to the mobile station, the second ECCLM includes information required to decode the BCCH.

31. The method of claim 30, further comprising the step of transmitting an extended system parameter message (ESPM) to the mobile station, the ESPM indicates whether the BCCH is supported.

32. The method of claim 30, wherein the first ECCLM indicates that the reference information of the BCCH is included so that the mobile station does not enter into a system determination substate for initialization.

33. The method of claim 30, wherein the information required to decode the BCCH includes BCCH frequencies, a data rate, a code rate, and walsh information.

34. A method for supporting handoff, the method comprising the steps of:
(a) receiving an extended system parameter message (ESPM) including a first field (BCCH_SUPPORTED) that indicates whether a Broadcast Control Channel (BCCH) is supported and an extended CDMA channel list message (ECCLM) including a second field (BCCH_INCL) that indicates whether reference information of the BCCH is included; and
(b) determining whether to enter into a system determination substate for initialization by analyzing at least one of the first field (BCCH_SUPPORTED) of the ESPM and the second field (BCCH_INCL) of the ECCLM.

35. The method of claim 34, wherein the mobile station does not enter into the system determination substate for initialization if the first field (BCCH_SUPPORTED) indicates that the BCCH is supported and the second field (BCCH_INCL) indicates that the reference information of the BCCH is included.

36. A method of performing a handoff for a mobile station in a mobile communication system, the method comprising the steps of:
transmitting an extended system parameter message (ESPM) to the mobile station, the ESPM including a BCCH_SUPPORTED field that indicates whether a broadcasting control channel (BCCH) is supported; and
transmitting an extended CDMA (code division multiplex access) channel list message (ECCLM) including a BCCH_INCL field that indicates whether reference information of the BCCH is included in the ECCLM.
